(19) United States
(12) Patent Application Publication
(10) Pub. No.: US 2006/0234197 A1
(43) Pub. Date: Oct. 19, 2006

(54) Portable karaoke device

(76) Inventor: John C. Suveizdis, Smyma, GA (US)

Correspondence Address: GEORGE R. REARDON, 3356 STATION COURT, LAWRENCVILLE, GA, 30044, US

(21) Appl. No.: 11/108,399

(22) Filed: Apr. 18, 2005

(51) Int. Cl. G10H 1/36; G10H 7/00

(52) U.S. Cl. 434/307 A

(57) ABSTRACT

The present invention relates generally to Karaoke devices and methods of making and using Karaoke devices. More particularly, the present invention relates to portable karaoke devices that are operable for mixing prerecorded Karaoke music with a live audio, storing the mixed performance and recording that Karaoke performance on a CD.

### FIELD OF THE INVENTION

The present invention is directed to playing and recording devices. More particularly, this invention relates to a portable karaoke player that records a karaoke performance on a CD.

### BACKGROUND OF THE INVENTION

Karaoke is a Japanese term that translates as “empty orchestra,” and has been a method of entertainment for years. Karaoke has no international or language boundaries. Karaoke involves the process of removing the sound tracks of vocals, guitar or both from existing recorded songs and allowing the Karaoke performer to fill in the empty spaces with his/her own interpretation of the performance, by singing, playing or singing and playing along with the remaining music tracks.

Thousands of selections of songs exist on karaoke CD's, with the lyrics being displayed in English as well as in various other languages. Generally written in a CD+G (CD plus graphics) format, the Karaoke performer can plug a karaoke system into a standard TV and have the lyrics (or chords, for guitaroke) displayed while the music is playing, so the Karaoke performer can follow along with the song.

Problems exist with the current Karaoke devices, however. If a Karaoke performer wants to keep a copy of his/her performance, the methods have traditionally been limited. One option for making a performance copy is to record on a cassette tape, generally using the cassette recorder integrated in a Karaoke device. Although useful in its time, cassettes are no longer the standard of choice for music reproduction and subsequent listening. Cassette players even have to be special ordered if one wants a cassette player in one's vehicle. A CD copy is the better choice since it can not only be played in a car, but also on the home stereo, as well as easily mailed to friends and family, and additionally can be changed into different formats, e.g. mp3, to be sent over the internet.

Another option is to use a home PC or laptop that has special software, e.g. MIDIMaster Karaoke plus RipEditBurn, installed that mixes the Karaoke sound tracks with the user input and then burns a CD containing the combined performance. One problem with this option is that since Karaoke has become such a social experience, as evidenced in the growth of karaoke night in many clubs and bars across the world, one might be reluctant to gather friends around the home computer for a karaoke party, thus risking having a drink spilt on the laptop.

Other proposed solutions include Chu U.S. Pat. No. 6,086,380, which teaches a personalized Karaoke recording studio in which the Karaoke performer sits in an enclosed recording booth.

None of these devices are designed to address the needs of portability of a Karaoke device with the ability to produce a CD which is playable on most commercially available CD players. Other problems exist that are not addressed by these devices.

Improvements are needed to facilitate convenient recording of a Karaoke performance. Therefore, it is an object of the present invention to provide a portable Karaoke CD recording device that overcomes these and other problems.

It is an object of the present invention to provide a Karaoke device that is portable.

It is an object of the present invention to provide a portable Karaoke device with integrated means for mixing a Karaoke CD with the Karaoke performer's input and creating a CD recording.

It is a further object of the present invention to provide a portable Karaoke device that is easy to use.

It is a further object of the present invention to provide a portable Karaoke device that contains an integrated speaker.

It is a further object of the present invention to provide a portable Karaoke device that can be used with existing Karaoke accessories, e.g. microphones, electric guitars, TVs, external speakers, and the like.

It is a further object of the present invention to provide a portable Karaoke device that is capable of being manufactured using existing machinery.

It is a further object of the present invention to provide a portable Karaoke device that can be used to play an instrument without singing, play an instrument and sing, or sing without playing an instrument.

It is a further object of the present invention to provide a portable Karaoke device that permits downloading of the Karaoke performance to a portable music device, e.g. iPod, MP3 player, and the like.

It is a further object of the present invention to provide a portable Karaoke device that permits wireless transmission of the Karaoke performance, e.g. via Wi-Fi, 802.11b, 802.11g, and other wireless transmission technologies.

It is a further object of the present invention to provide a portable Karaoke device that can be used both for personal use and for commercial use, e.g. by club and bar owners connecting the portable Karaoke device directly to their house system so they can offer a patron a CD copy of his/her performance.

### SUMMARY OF THE INVENTION

The aforementioned and other objects were achieved, and the above-mentioned disadvantages overcome, by the present invention, by providing a portable Karaoke device that can also create a CD of the Karaoke performance.

The present invention is directed to producing a CD of a Karaoke performance using a device which is portable. In a preferred embodiment of the invention the portable Karaoke device is comprised of a module operable for playing a Karaoke CD and outputting Karaoke lyrics and/or chords to a display while outputting the Karaoke melody to a mixing module. The portable Karaoke device is further comprised of modules operable for taking the audio inputs of a microphone and/or an instrument and sending the inputs to a mixing module. The portable Karaoke device is further comprised of a mixing module that mixes the melody from the Karaoke CD with the audio inputs from the microphone and/or an instrument and stores the combined performance. The portable Karaoke device is further comprised of a module that outputs/erases the stored combined performance based on user commands. The portable Karaoke device is further comprised of a module that burns a CD when the user command is to output the stored combined performance.

In general, the portable Karaoke device is designed for portable use and all components are enclosed and connected in a single housing. An input signal from an external device, e.g. a microphone, guitar, that is connected to the dedicated input jacks (¼″ standard, and/or XLR) located on the front of the portable Karaoke device, is transmitted via wire connections and combined with the output signal transmitted from the Karaoke CD Player (format CD+G). This combined signal is then sent via wire connections to the primary circuit board for signal translation. The resulting translated signal is then transmitted via wire connections from the primary circuit board to the secondary circuit board (effects processing module) for AD conversion, if required, that manipulates the signal based on user commands to add/subtract volume/reverb/pitch transpose, etc. The resulting audio output is then transmitted via wire connections to the amplifier where the processed signal is sent via wire connections to the internal speaker. The wire connection audio signal is also split to the output jacks (¼″ standard and/or RCA) for further transmission to external sources such as the speaker out, line out, headphone out, and auxiliary out. The audio signal is simultaneously sent to a computer processor memory chip for storage and signal conversion to be downloaded to the CD recorder, based on user commands. The converted processor signal is also sent to the USB port mounted in the back of the portable Karaoke device for connection to an external device such as an iPOD or WI-Fl transmitter. The video, or graphics signal from the CD+G disc in the Karaoke CD player is simultaneously sent to the primary circuit board and transmitted via wire to video out jacks for RCA and/or S-Video transmission for an external video display device.

When the recording process is complete, a user command from the control panel causes the microprocessor to code the CD-R/CD-RW disc in the CD recorder and finalize the process which writes the code to the CD-R/CD-RW disc to enable the recorded CD for playback in any standard CD player. The microprocessor can also store the performance in memory for playback preview, and/or downloaded at the discretion of the user.

Additional objects and advantages of the invention will be set forth in part in the description which follows, and in part will be obvious from the description, or may be learned by practice of the invention. The objects and advantages of the invention will be obtained by means of instrumentalities in combinations particularly pointed out in the appended claims.

### BRIEF DESCRIPTION OF THE DRAWINGS

The accompanying drawings illustrate a complete embodiment of the invention according to the best modes so far devised for the practical application of the principles thereof, and in which:

FIG. 1 shows a front plan view of a portable Karaoke device according to a preferred embodiment of the present invention.

FIG. 2 shows a front plan view of a portable Karaoke device according to a preferred embodiment of the present invention.

FIG. 3 shows a back plan view of a Karaoke device according to a preferred embodiment of the present invention.

FIG. 4 shows a front plan view of a Karaoke device according to an alternate embodiment of the present invention.

FIG. 5 shows a top plan view of a Karaoke device according to an alternate embodiment of the present invention.

### DETAILED DESCRIPTION OF THE INVENTION

The drawings show aspects of the invention. As the drawings are described, reference will be made to the present preferred embodiments of the invention. The terminology used herein to describe the present preferred embodiments is for the purpose of clarification. The invention, however, is not intended to be limited to the specific terminology used. Terminology used to describe each element should be understood to include all technical equivalents that operate in a similar manner to accomplish similar functions.

The present invention is described in relation to a portable Karaoke device. Nonetheless, the characteristics and parameters pertaining to various embodiments the device and methods described herein may be applicable for other uses.

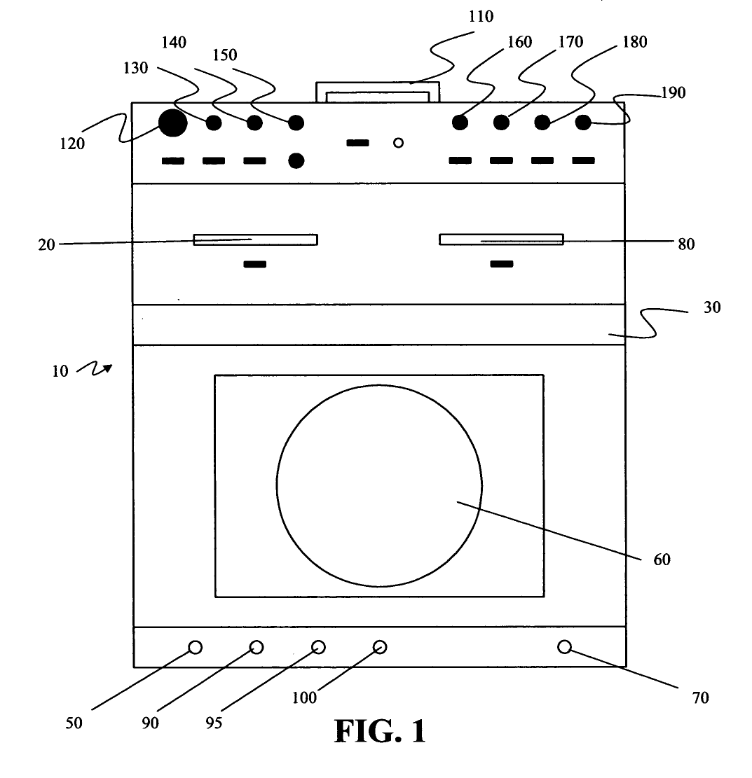

Referring to FIG. 1, a preferred embodiment of the present invention is shown as device 10. Device 10 is further comprised of Karaoke CD player 20, control panel display 30, first microphone input 50, speaker 60, headphone output 70, CD recorder 80, second microphone input 90, third microphone input 95, guitar input 100, handle 110, master select 120, master volume 130, effect select 140, mix 150, bass 160, mid 170, treble, 180, headphone volume 190.

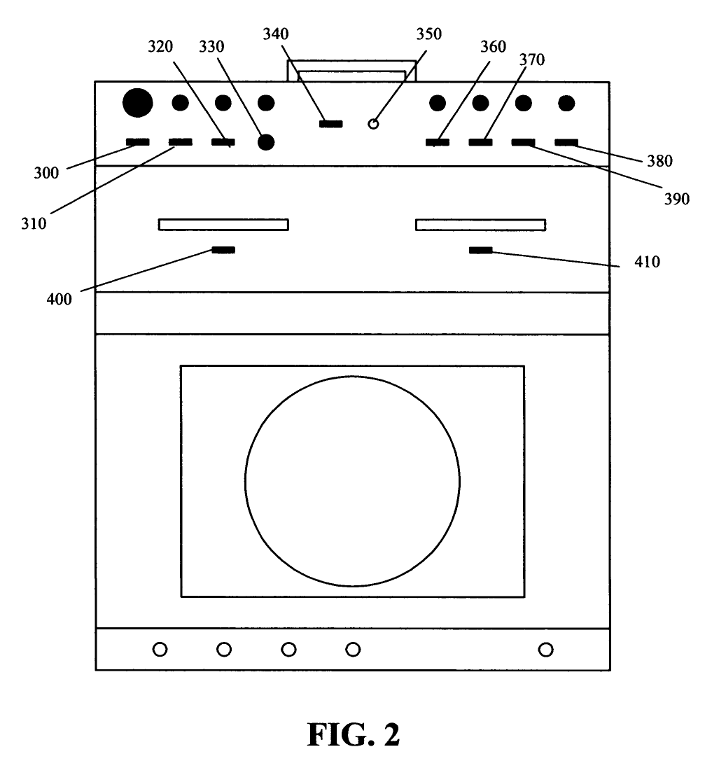

Referring to FIG. 2, device 10 is further comprised of comprised of Karaoke play button 300, Karaoke stop button 310, Karaoke pause button 320, Karaoke select knob 330, power on-off 340, power indicator 350, CD record button 360, CD play button 370, CD stop button 380, CD finalize button 390, Karaoke CD eject button 400, CD recorder eject button 410.

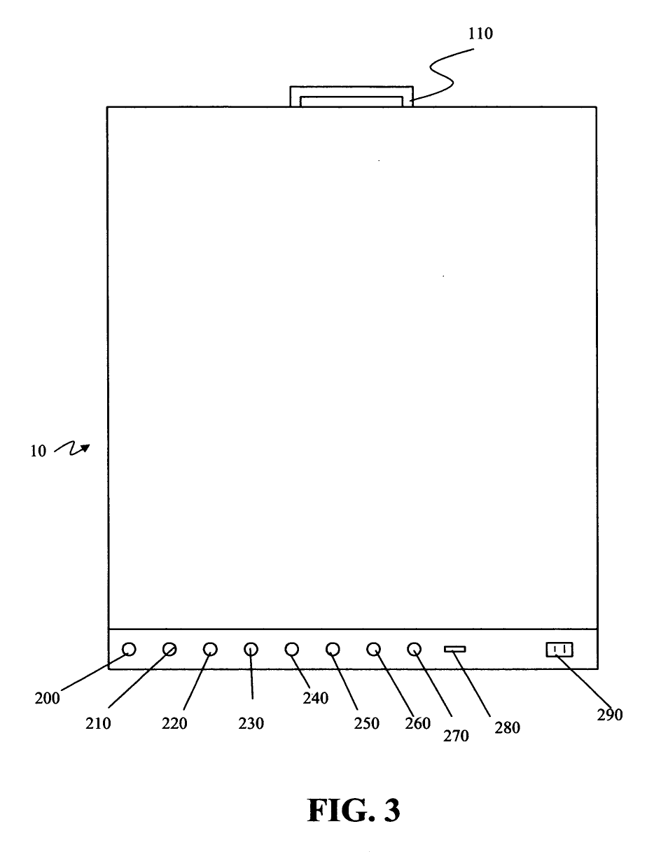

Referring now to FIG. 3, device 10 is further comprised of left speaker output 200, right speaker output 210, video in 220, first video out 230, second video out 240, s-video out 250, line out 260, auxiliary out 270, USB port 280, battery holder 285 (not shown), power outlet 290. Handle 110 is also shown.

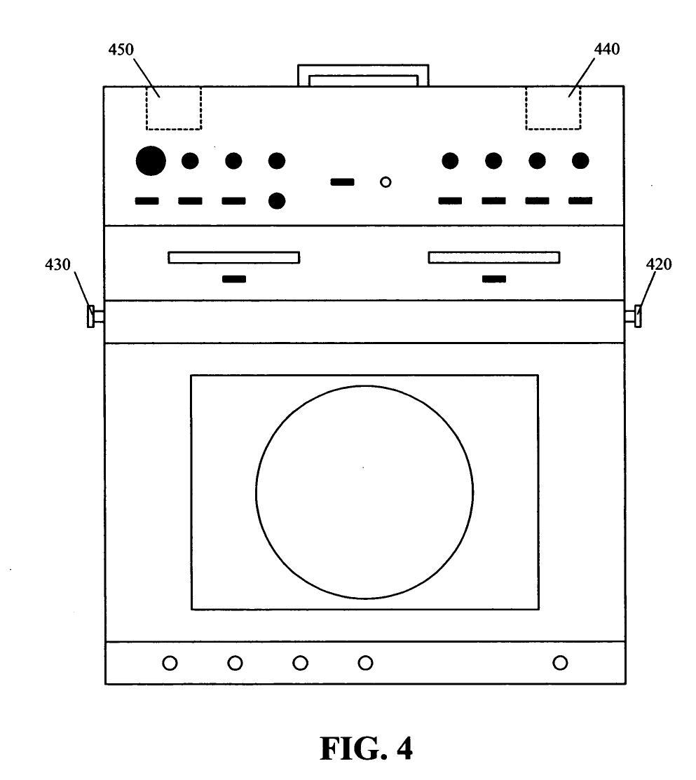

Referring now to FIG. 4, an alternate embodiment of device 10 is further comprised of first beverage holder 440, second beverage holder 450, first microphone holder 420 and second microphone holder 430.

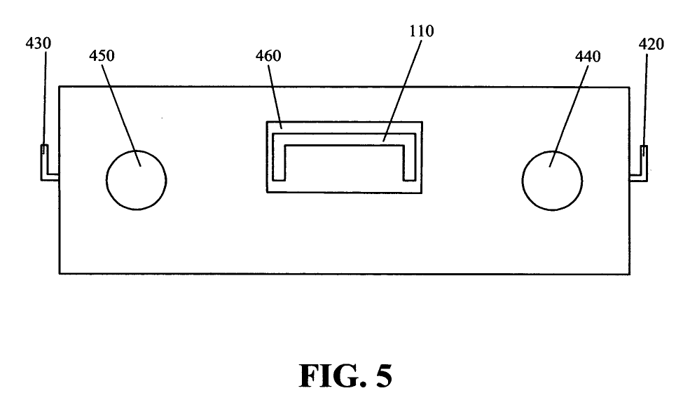

Referring now to FIG. 5, an alternate embodiment of device 10 is further comprised of handle recess 460. First beverage holder 440, second beverage holder 450, first microphone holder 420, second microphone holder 430 and handle 110 are also shown.

The preferred dimensions of the external housing for the present invention is a height of 26″, a width of 15½″ and a depth of 12½″. The external housing can be constructed from metal, plastic, wood, or combinations thereof. A hinged, recessed carrying handle is in the center top of the housing. The preferred Watt capacity of speaker 60 is from 20 W to 200 W. The preferred version of control panel display 30 is a standard LCD display.

The preferred process of making the present invention is as follows:
Forming the housing for reception of the portable Karaoke components
Installing the input jacks, output jacks, USB port, knobs buttons, indicators and power receptacle
Installing the speaker,
Installing the CD drives
Installing the amplifier
Installing the printed circuit boards
Installing the microprocessor with preloaded software, storage capacity, signal conversion means and signal transmission means
Operably connecting all components

The preferred process of using the present invention is as follows:
Connecting desired external accessories, e.g. TV monitor, additional speakers, guitar
Connecting power outlet 290 to a source of power
Pressing power on-off button 340 to turn on device 10
Pressing Karaoke CD eject button 400
Placing a Karaoke CD into Karaoke CD player 20
Pressing Karaoke CD eject button 400 in order to close Karaoke CD player 20
Pressing CD recorder eject button 410
Placing a blank recordable CD into CD recorder 80
Pressing CD recorder eject button 410 in order to close CD recorder 80
Turning Karaoke select knob 330 in order to select the desired Karaoke track to play
Turning master volume 130 to obtain desired speaker volume
Turning effect select 140 to desired effect, e.g. reverb, pitch control
Turning mix 150 to blend in desired level of effect
Turning volume mix 160 to blend in vocal/guitar to the song being played
Turning Karaoke select knob 330 in order to start at the beginning of the desired melody
Pressing Karaoke play button 300
Pressing CD record button 360
Performing in synch with the Karaoke CD until reaching the desired stopping point
Pressing CD stop button 380
Pressing Karaoke stop button 310
Pressing CD play button 370
Listening to Karaoke performance
Pressing CD finalize button 390 if satisfied with the recording
Pressing CD recorder eject button 410 to open CD recorder 80
Removing recorded CD from CD recorder 80
Pressing CD recorder eject button 410 to close CD recorder 80
Pressing power on-off 340

Other embodiments, uses and advantages of the present invention will be apparent to those skilled in the art from consideration of the specification and practice of the invention disclosed herein. The specification and examples should be considered exemplary only.

What is claimed is:

1) A portable karaoke device comprising:
a housing, wherein said housing has a top side, a bottom side, a front side, a back side, a left side and a right side;
at least one handle operably connected to said top side for carrying said portable karaoke device;
at least one audio microphone input means;
an audio speaker system;
power means;
a control panel;
audio selection means;
audio effects means;
audio volume means;
audio playing means;
graphics displaying means;
audio mixing means;
audio storage means;
audio recording means; and
CD dispensing means.

2) The portable karaoke device according to claim 1, further comprising:
audio erasing means;
instrument input means;
headphone output means;
a USB port;
auxiliary speaker means;
auxiliary output means; and
battery holding means.

3) The portable karaoke device according to claim 2, further comprising:
at least one beverage holding recess disposed in said top side;
a first microphone holding clip operably connected to said right side a second microphone holding clip operably connected to said left side; and
a handle recess for said handle disposed in said top side.

4) A method of making a portable karaoke device, comprising the steps of:
forming the housing for reception of components for said portable Karaoke device;
installing input jacks;
installing output jacks;
installing USB port;
installing control knobs;
installing control buttons;
installing power indicator;
installing power receptacle;
installing speaker;
installing CD drives;
installing amplifier;
installing printed circuit boards;
installing microprocessor with mixing means, storage means signal conversion means, transmission means, recording means; erasing means; and,
operably connecting all components

5) A method of using a portable karaoke device comprising the steps of:
connecting desired external accessories;
connecting power outlet to a source of power;
pressing power on-off button;
pressing Karaoke CD eject button;
placing a Karaoke CD into Karaoke CD player;
pressing said Karaoke CD eject button in order to close said Karaoke CD player;
pressing CD recorder eject button;
placing a blank recordable CD into CD recorder;
pressing said CD recorder eject button in order to close said CD recorder;
turning Karaoke select knob in order to select the desired Karaoke track to play;
turning master volume to obtain desired speaker volume;
turning effect select to desired effect;
turning mix to blend in desired level of effect;
turning Karaoke select knob in order to start at the beginning of the desired melody;
pressing Karaoke play button;
pressing CD record button;
performing in synch with the Karaoke CD until reaching the desired stopping point;
pressing CD stop button;
pressing Karaoke stop button;
pressing CD play button;
listening to Karaoke performance;
pressing CD finalize button to create recorded CD;
pressing said CD recorder eject button to open said CD recorder;
removing said recorded CD from said CD recorder;
pressing said CD recorder eject button to close said CD recorder 80; and,
pressing power on-off.
